(19) United States
(12) Patent Application Publication
(10) Pub. No.: US 2012/0327493 A1
(43) Pub. Date: Dec. 27, 2012

(54) MIRROR DEVICE

(75) Inventors: Akira KOIDE, Inashiki (JP); Norio HOSAKA, Yokohama (JP)

(73) Assignee: HITACHI MEDIA ELECTRONICS CO., LTD., Iwate (JP)

(21) Appl. No.: 13/430,825

(22) Filed: Mar. 27, 2012

(30) Foreign Application Priority Data
Jun. 22, 2011 (JP) 2011-138131

(51) Int. Cl. G02B 26/10

(52) U.S. Cl. 359/199.2

(57) ABSTRACT

In a biaxial mirror device where beams for connecting a first movable frame to a second movable frame and the second movable frame to a fixed frame pass a center of the mirror along an axis, an actuator for moving the second movable frame is composed of two first and second actuators and in a state that rotational angles of the movable frames are zero, the first actuator permits the second movable frame to start rotation and when it reaches a specific rotational angle, the second actuator permits the second movable frame to rotate, thus a large deflection angle is obtained even by the dissonance drive.

### CLAIM OF PRIORITY

The present application claims priority from Japanese patent application serial No. 2011-138131, filed on Jun. 22, 2011, the content of which is hereby incorporated by reference into this application.

### FIELD OF THE INVENTION

The present invention relates to a mirror device loaded in an image projector such as a microminiature projector for projecting an image.

### BACKGROUND OF THE INVENTION

Generally, a projector projects an image on a large screen in a movie theater or a conference room and is used as equipment for permitting many people to share information at a time.

However, recently, the commercialization of a microminiature projector capable of being loaded in a portable telephone such as a pico-projector using an LED (light emitting diode) or an LD (laser diode) is in progress.

The pico-projector is recently noted as a device capable of projecting an image in any favorite place and the Nikkei Electronics for 2010, August to September predicts that in 2014, more than 20,000,000 issues will be shipped yearly.

As a display device for the pico-projector, there are three mirror devices available such as LCOS (liquid crystal on silicon), DMD (digital micro-mirror device), and MEMS (micro electro mechanical systems) and at the present stage, the LCOS and DMD are main devices. However, there is an advantage that by a combination with an LD, a focus-less optical system can be constructed, so that the development of the MEMS mirror device is in progress.

For the MEMS mirror device, for moving image projection by a projector, a horizontal and vertical biaxial mirror is necessary and in correspondence with the WVGA (800×480), it is requested to drive at greatly different scanning speeds such as horizontal direction ±11° at 18 kHz and vertical direction ±6° at 60 Hz.

As an example, the electromagnetic drive type mirror device of Microvision, Ltd. disclosed in Patent document 1 is a biaxial mirror device and drives the outside movable frame vertically at a dissonance frequency and the inside mirror horizontally at a resonance frequency. The coil for generating Lorentz force is formed in the outside movable frame, and a magnet is arranged on the 45° axial line to the two movable axial directions of the mirror device, thus the Lorentz force for the two axes is generated by the outside movable frame.

As an example of a piezoelectric drive type mirror device, there is a biaxial mirror device of Stanley Electric Co., Ltd. that is disclosed in Patent document 2. In this example, the movable portion where the mirror face is formed, the movable frame for supporting the movable portion, and the fixed frame for supporting the movable frame are installed. And, the movable portion and the movable frame are connected with a hinge and the movable frame and the fixed frame are connected with cantilever beams connected in a zigzag shape. On the hinge for connecting the mirror and movable frame, a piezoelectric actuator is formed, and it is driven at the resonance frequency, thus a large deflection angle is obtained. Further, the movable frame can apply voltages different in the polarity to the piezoelectric materials formed on the adjacent cantilever beams.

As an example of an electrostatic drive type mirror device, there is a uniaxial mirror device of Panasonic Denko Co., Ltd. that is disclosed in Patent document 3. In this example, the movable portion with the mirror face formed and the fixed frame for supporting the movable portion are installed and the movable portion and the fixed frame are mutually connected with a hinge.

Further, a pair of comb-tooth electrodes which are formed between the movable portion and the fixed frame and mesh with each other are attached, use the electrostatic force when a voltage is applied to the pair of comb-tooth electrodes as driving force, rotate around the fixed frame by twisting the hinge, and swing on an axis of the hinge.

In this example, to ensure the deflection angle necessary to scan light at a small drive voltage, the movable portion of the optical scanning mirror and the position where the hinge is installed are hermetically sealed at a low pressure, thus a high Q value (an amplitude amplification factor at the resonance frequency) is realized.

### PRIOR ART DOCUMENT

### Patent Document

Japanese Patent Laid-open No. 2007-522529
Japanese Patent Laid-open No. 2008-40240
Japanese Patent Laid-open No. 2010-8613

### SUMMARY OF THE INVENTION

The promising driving systems of the mirror device are the three kinds of electromagnetic drive type, piezoelectric drive type, and electrostatic drive type which are aforementioned and the simplest driving system realizing low cost is the electrostatic drive type.

The defect of the electrostatic drive type is a high drive voltage, though the horizontal direction ±11° at 18 kHz drive can be coped with by the method disclosed in Patent Literature 3. However, regarding the vertical direction ±6° at 60 Hz drive, the resonance frequency cannot be lowered to 60 Hz from the viewpoint of the disturbance resistance as a display device, so it is necessary to obtain a large deflection angle by the dissonance drive.

An object of the present invention is to provide a mirror device capable of driving a mirror at a low voltage by moving a second variable frame in combination with a first electrostatic actuator with a second electrostatic actuator which are different in the properties and reproducibly obtaining a large deflection angle by moving the movable frame until the mirror comes into contact with the insulators formed on the inclined electrodes.

The object of the present invention, in the mirror device including a mirror for scanning a laser beam on a face as a screen and projecting an image, a first movable frame with the mirror attached thereto, a second movable frame connected to the first movable frame via a first beam, and a fixed frame connected to the second movable frame via a second beam, is accomplished by combining the comb teeth formed in the first movable frame with the comb teeth formed in the second movable frame, forming the first electrostatic actuator by combining the comb teeth formed in the second movable frame with the comb teeth formed in the fixed frame, installing the second electrostatic actuator composed of inclined electrodes under the first movable frame and the second movable frame, and moreover permitting the mirror to operate horizontally and vertically by the first and second actuators.

Further, in the above object, it is preferable that the mirror rotates biaxially by the first beam and second beam.

Further, in the above object, it is preferable that the first actuator supports the parallel flat plate type electrostatic actuator with a cantilever beam, and in the state that the parallel flat plate electrodes connected to the leading edge of the cantilever beam are pulled near and come into contact with the fixed electrodes by electrostatic force, the cantilever beam moves in the contact area from the parallel flat plate electrode side to the second movable frame, and after the second movable frame exceeds a predetermined rotational angle, the electrostatic force of the second electrostatic actuator using the inclined fixed electrodes increases, thus the mirror is rotated more. Further, in the above object, it is preferable that the first actuator is a comb-tooth electrode type electrostatic actuator, and the positions in the height direction of the comb-tooth electrodes installed on the side of the second movable frame and the comb-tooth electrodes installed on the side of the fixed frame have an offset, and after the second movable frame is rotated by the electrostatic force when a voltage is applied between the comb-tooth electrodes and exceeds the predetermined rotational angle, the force of the second electrostatic actuator using the inclined fixed electrodes increases, thus the mirror is rotated.

Further, in the above object, it is preferable that the actuator for driving in the horizontal direction is an electrostatic actuator for rotating the first movable frame by electrostatic force when a voltage is applied between the comb-tooth electrodes, wherein the positions in the height direction of the comb-tooth electrodes installed on the side of the second movable frame and the comb-tooth electrodes installed on the side of the fixed frame have an offset and the actuator is driven at the resonance frequency of the system with the first movable frame and mirror united.

Further, in the above object, it is preferable that the mirror and the first movable frame and second movable frame are hermetically sealed spatially with the cover where the second movable frame is joined to the fixed frame portion and the pressure of the hermetically sealed space is 1,000 Pa or lower.

### ADVANTAGEOUS EFFECTS OF INVENTION

According to the present invention, the first electrostatic actuator and the second electrostatic actuator which are different in properties are combined, and the second movable frame is moved, thus even at a low voltage, the mirror can be driven, and the movable frame is moved until the mirror makes contact with the insulators formed on the inclined electrodes, thereby a large deflection angle can be repeatedly obtained.

### BRIEF DESCRIPTION OF THE DRAWINGS

FIG. 1 is a drawing showing the operation principle of the laser scanning projector.

FIG. 2 is a cross sectional view of the biaxial electrostatic drive mirror device stored in the pressure control enclosed space.

FIG. 3 is a front view of the biaxial electrostatic drive mirror device relating to Embodiment 1 of the present invention.

FIG. 4 is a cross sectional view of the line A-A shown in FIG. 3.

FIG. 5 is a cross sectional view of the line B-B shown in FIG. 3.

FIG. 6 is an enlarged view of the inclined electrodes relating to Embodiment 1 of the present invention.

FIG. 7 is a front view of the biaxial electrostatic drive mirror device relating to Embodiment 2 of the present invention.

FIG. 8 is a front view of the biaxial electrostatic drive mirror device relating to Embodiment 3 of the present invention.

FIG. 9 is a front view of the biaxial electrostatic drive mirror device relating to Embodiment 4 of the present invention.

FIG. 10 is an enlarged view of the inclined electrodes relating to each embodiment of the present invention.

FIG. 11 is a partially enlarged view of the comb-tooth type actuator.

FIG. 12 is a cross sectional view of the line C-C shown in FIG. 11.

### DESCRIPTION OF THE PREFERRED EMBODIMENTS

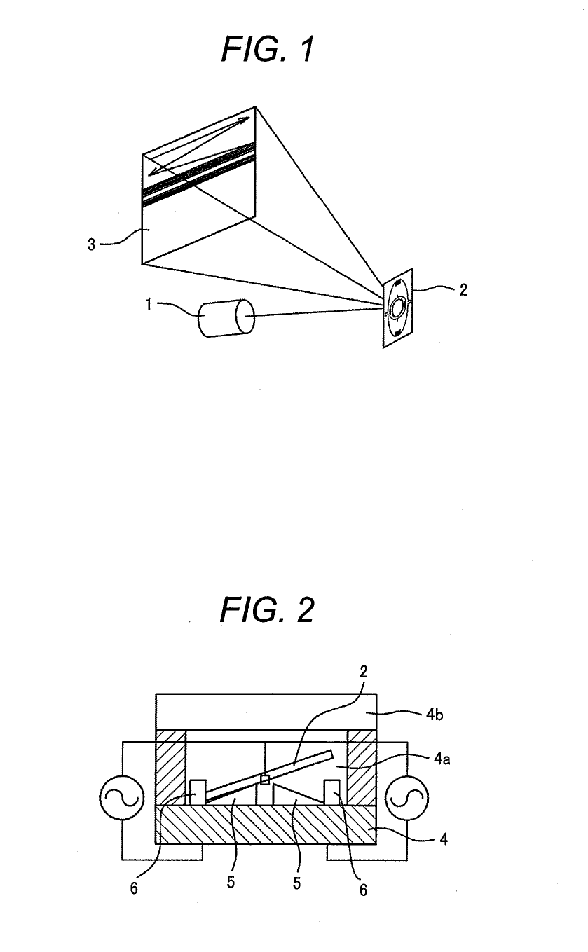

The laser scanning projector will be explained briefly by referring to FIGS. 1 and 2.

FIG. 1 is a drawing showing the operation principle of the laser scanning projector.

FIG. 2 is a cross sectional view of the biaxial electrostatic drive mirror device stored in the pressure control enclosed space.

In FIG. 1, from a laser source 1, beams from the respective laser beam sources of R, G, and B are collimated, and the color-composed beam is permitted to enter a mirror 2 and is scanned two-dimensionally, thus a two-dimensional image is drawn on a screen 3. The mirror 2 permits the scanned laser spot to meander horizontally to the screen 3 and operate vertically, thereby draw a two-dimensional image.

The mirror 2 will be explained by referring to FIG. 2.

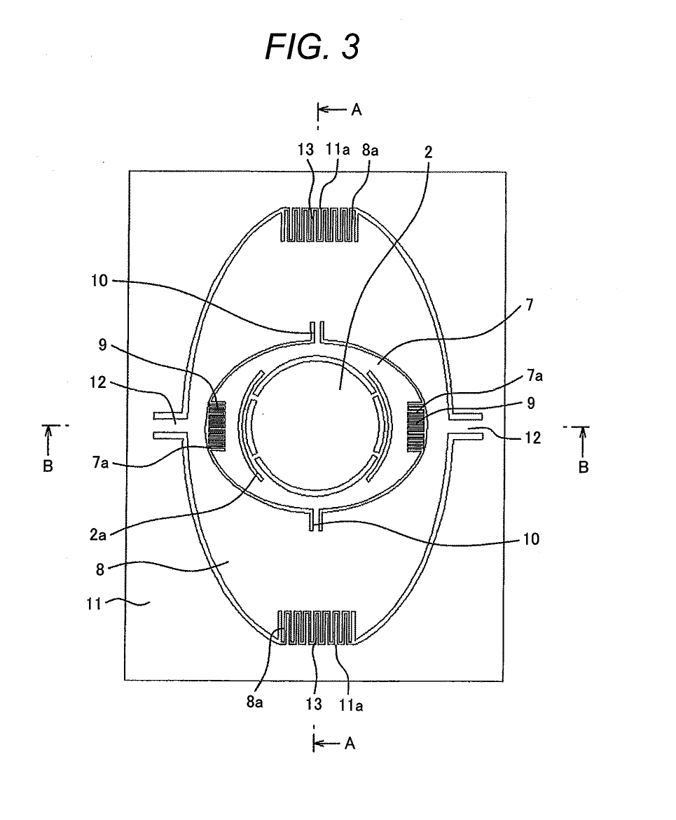

In FIG. 2, the mirror 2 is stored in a pressure control enclosed space 4a formed by an enclosed container 4. Regarding the enclosed container 4, to permit the laser spot to pass through, the opening of the top is blocked with a glass plate 4b. Right under the mirror 2, inclined electrodes 5 are attached. To the outer periphery of the mirror 2, the movable frame, which will be described later (the details will be explained in FIG. 3), is connected and the portions overlapped with the inclined electrodes 5 are comb-tooth electrodes 6 (the details will be explained in FIG. 3). These electrodes are applied with an AC voltage to operate.

Hereinafter, the details of the mirror device relating to an embodiment of the present invention will be explained with reference to the drawings.

### Embodiment 1

Regarding this embodiment, the case where it is used for image drawing will be explained as an embodiment by referring to FIGS. 3 to 9.

FIG. 3 is a front view of the mirror device relating to the first embodiment of the present invention.

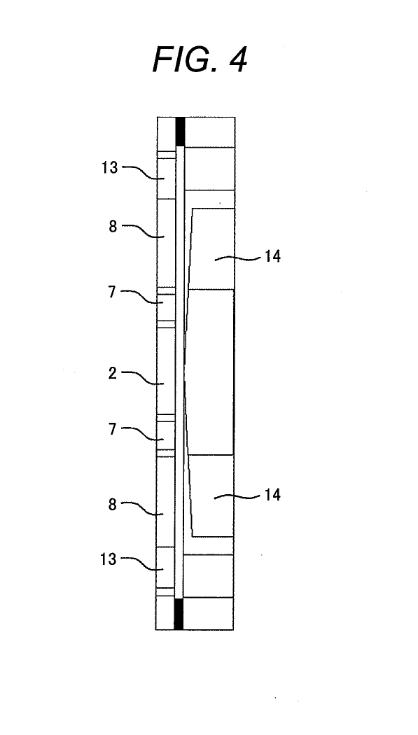

FIG. 4 is a cross sectional view of the line A-A shown in FIG. 3.

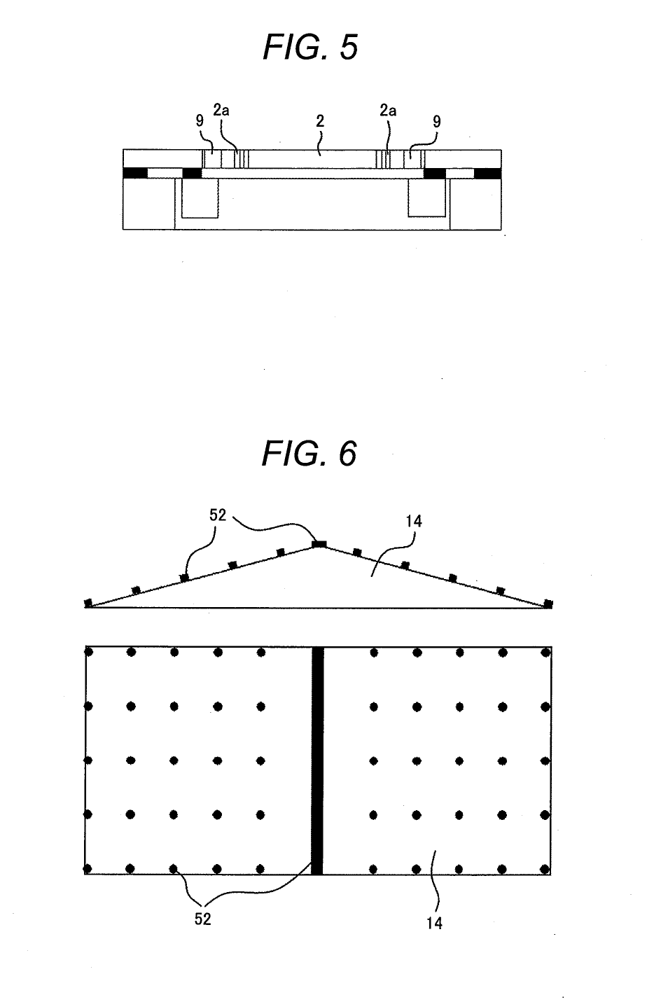

FIG. 5 is a cross sectional view of the line B-B shown in FIG. 3.

In FIG. 3, the mirror 2 for reflecting light is connected to a first movable frame 7 via a distortion separation portion 2a and is fixed in the same plane. The distortion separation portion 2a prevents the mirror 2 from deforming due to a temperature change or force applied at the time of mounting.

The first movable frame 7 is connected to a second movable frame 8 with torsion beams 10 symmetrically arranged on the axial line passing the center of the mirror. Further, the first movable frame 7 rotates around the axis composed of the torsion beams 10 by comb-tooth electrode type electrostatic actuators 9 formed at the ends in the rotational direction. If the first movable frame 7 is used to draw an image in the horizontal direction, the drive frequency thereof is high such as 10 kHz or higher.

When the resonance frequency is high like this, the comb-tooth electrode electrostatic actuators 9 are driven by applying an AC voltage having the same frequency as the resonance frequency of the system including the structure existing inside the first movable frame 7 between comb-tooth electrodes 7a formed in the first movable frame 7 and comb-tooth electrodes 8a formed in the second movable frame 8.

By doing this, the amplification of the deflection angle due to the resonance phenomenon is realized and even at a low voltage such as 10V or lower, the mirror 2 can be swung at a large deflection angle on a rotary axis of the torsion beams 10.

Further, the amplification factor of the deflection angle due to the resonance phenomenon depends on the surrounding pressure and to increase the amplification factor, the drive system including the mirror 2, as shown in FIG. 2, is hermetically sealed in the pressure control enclosed space 4a which is evacuated.

If the second movable frame 8 is used to draw an image in the vertical direction, the drive frequency thereof is 60 Hz. When the drive frequency is low like this, if the resonance frequency is lowered, the behavior of the mirror 2 becomes unstable under the influence of a disturbance vibration and the second movable frame 8 becomes unsuitable for image drawing. Therefore, the dissonance drive is used and the resonance frequency of the system is set to hundreds of Hz or higher so as to be hardly affected by the disturbance vibration.

The constitution for rotating the second movable frame 8 without using the phenomenon that the deflection angle due to the resonance phenomenon is amplified will be explained below.

The second movable frame 8 is connected to a fixed frame 11 with torsion beams 12 formed on the axial line passing the center of the mirror 2 and rotates around the axis composed of the torsion beams 12 by comb-tooth electrode type electrostatic actuators 13 formed at the ends in the rotational direction. The comb-tooth electrode type electrostatic actuators 13 are driven by applying an AC voltage at 60 Hz between the comb-tooth electrodes 8a formed in the second movable frame 8 and comb-tooth electrodes 11a fixed to the fixed frame 11.

Here, the deflection angle of the mirror 2 depends on the balance between the electrostatic force generated by the electrostatic actuator and the reaction force generated by torsion of the torsion beams 12, so that if the rigidity of the torsion beams 12 is designed so as to have a resonance frequency of hundreds of Hz or higher, at an AC voltage of 10V or lower, the mirror deflects only several times.

Therefore, an inclined electrode type electrostatic actuator 14 is installed on the second movable frame 8.

The inclined electrode type electrostatic actuator 14 will be explained by referring to FIGS. 4 and 5.

In FIGS. 4 and 5, the mirror 2 for reflecting light is connected to the first movable frame 7 via the distortion separation structure 2a and is fixed in the same plane. The distortion separation portion 2a prevents the mirror 2 from deforming due to a temperature change or force applied at the time of mounting. The first movable frame 7 is connected to the second movable frame 8 with the torsion beams 10 symmetrically arranged on the axial line passing the center of the mirror and rotates around the axis composed of the torsion beams 10 by the comb-tooth electrode type electrostatic actuators 9 formed at the ends in the rotational direction. If the first movable frame 7 is used to draw an image in the horizontal direction, the drive frequency thereof is high such as 10 kHz or higher.

When the resonance frequency is high like this, the comb-tooth electrode type electrostatic actuators 9 are driven by applying an AC voltage having the same frequency as the resonance frequency of the system including the structure existing inside the first movable frame 7 between the comb-tooth electrodes formed in the first movable frame 7 and the comb-tooth electrodes fixed to the second movable frame 8.

By doing this, the amplification of the deflection angle due to the resonance phenomenon is realized and even at a low voltage such as 10V or lower, the mirror 2 can be swung at a large deflection angle for a rotary shaft of the torsion beams 10. Further, the amplification factor of the deflection angle due to the resonance phenomenon depends on the surrounding pressure and to increase the amplification factor, the drive system including the mirror 2 is hermetically sealed spatially at a low pressure.

If the second movable frame 8 is used to draw an image in the vertical direction, the drive frequency thereof is 60 Hz. When the drive frequency is low like this, if the resonance frequency is lowered, the behavior of the mirror 2 becomes unstable under the influence of a disturbance vibration and the second movable frame 8 becomes unsuitable for image drawing. Therefore, the dissonance drive is used and the resonance frequency of the system is set to hundreds of Hz or higher so as to be hardly affected by the disturbance vibration.

The constitution for rotating the second movable frame 8 without using the phenomenon that the deflection angle due to the resonance phenomenon is amplified will be explained below.

The second movable frame 8 is connected to the fixed frame 11 with the torsion beams 12 formed on the axial line passing the center of the mirror 2 and rotates around the axis composed of the torsion beams 12 by the comb-tooth electrode type electrostatic actuators 13 formed at the ends in the rotational direction. The comb-tooth electrode type electrostatic actuators 13 are driven by applying an AC voltage at 60 Hz between the comb-tooth electrodes 8a formed in the second movable frame 8 and the comb-tooth electrodes 11a fixed to the fixed frame 11.

Here, the deflection angle of the mirror 2 depends on the balance between the electrostatic force generated by the electrostatic actuator and the reaction force generated by torsion of the torsion beams 12, so that if the rigidity of the torsion beams 12 is designed so as to have a resonance frequency of hundreds of Hz or higher, at an AC voltage of 10V or lower, the mirror deflects only several times.

Therefore, the inclined electrode type electrostatic actuator 14 is installed in the second movable frame 8.

The reason for using the inclined electrode type electrostatic actuator is that the electrostatic force is inversely proportional to the square of the distance between the electrodes, so that if each fixed electrode is inclined and the distance to each movable electrode is brought limitlessly close to zero, a large electrostatic force can be obtained. However, to obtain a large deflection angle, the inclination angle needs to be inclined in correspondence to the deflection angle, so that at an early stage, a large electrostatic force cannot be obtained, thus the distance between the inclined electrodes is narrowed by the electrostatic actuator 14 to obtain a large force.

FIG. 6 is an enlarged view of the inclined electrodes.

In FIG. 6, on the surface of the inclined electrodes 14, a plurality of insulators 52 protruding from the surface is installed. The insulators 52 function as a stopper when the second movable frame 8 is pulled near the side of the inclined electrodes 14 by the electrostatic force, so that the deflection angle of the second movable frame 8 is always controlled to the inclination angle of the inclined electrodes 14.

In other words, the insulators 52 prevent the second movable frame 8 from adhesion to the surface of the inclined electrodes 14.

As mentioned above, in this embodiment, the movable frame cannot be inclined sufficiently only by the comb-tooth electrode, so that the inclined electrodes are combined. Namely, the comb-tooth electrode produces a chance of inclination of the movable frame and then the inclined electrodes permit the mirror to swing at a desired inclination.

### Embodiment 2

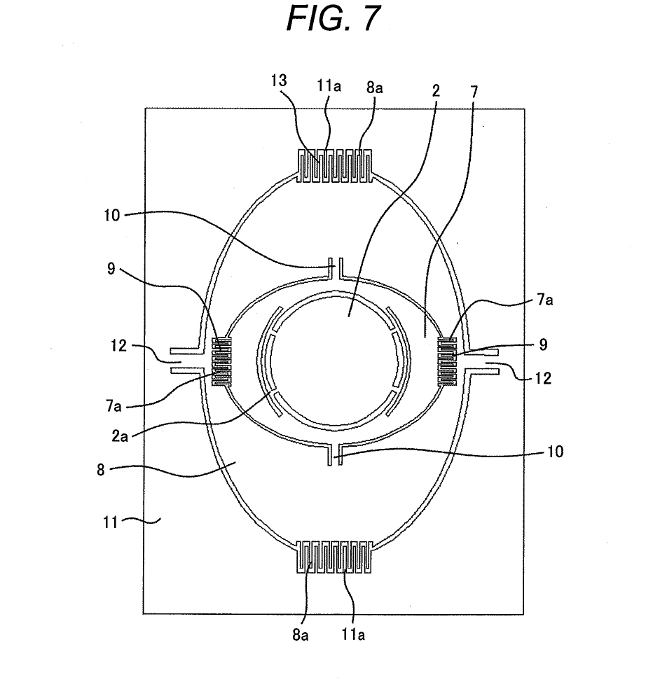

FIG. 7 is a front view of the biaxial electrostatic drive mirror device relating to Embodiment 2 of the present invention.

In FIG. 7, the mirror 2 for reflecting light is connected to the first movable frame 7 via the distortion separation portion 2a and is fixed in the same plane. The distortion separation structure 2a prevents the mirror 2 from deforming due to a temperature change or force applied at the time of mounting.

The first movable frame 7 is connected to the second movable frame 8 with the torsion beams 10 symmetrically arranged on the axial line passing the center of the mirror and rotates around the axis composed of the torsion beams 10 by the comb-tooth electrode type electrostatic actuators 9 formed at the ends in the rotational direction. If the first movable frame 7 is used to draw an image in the horizontal direction, the drive frequency thereof is high such as 10 kHz or higher.

When the resonance frequency is high like this, the comb-tooth electrode type electrostatic actuators 9 are driven by applying an AC voltage having the same frequency as the resonance frequency of the system including the structure existing inside the first movable frame 7 between the comb-tooth electrodes 7a formed in the first movable frame 7 and the comb-tooth electrodes 8a formed in the second movable frame 8.

By doing this, the amplification of the deflection angle due to the resonance phenomenon is realized and even at a low voltage such as 10V or lower, the mirror 2 can be swung at a large deflection angle for a rotary shaft of the torsion beams 10. Further, the amplification factor of the deflection angle due to the resonance phenomenon depends on the surrounding pressure and to increase the amplification factor, the drive system including the mirror 2 is hermetically sealed spatially at a low pressure.

If the second movable frame 8 is used to draw an image in the vertical direction, the drive frequency thereof is 60 Hz. When the drive frequency is low like this, if the resonance frequency is lowered, the behavior of the mirror 2 becomes unstable under the influence of a disturbance vibration and the second movable frame 8 becomes unsuitable for image drawing. Therefore, the dissonance drive is used and the resonance frequency of the system is set to hundreds of Hz or higher so as to be hardly affected by the disturbance vibration. The mechanism for rotating the second movable frame 8 without using the phenomenon that the deflection angle due to the resonance phenomenon is amplified will be explained below.

The second movable frame 8 is connected to the fixed frame 11 with the torsion beams 12 formed on the axial line passing the center of the mirror 2 and rotates around the axis composed of the torsion beams 12 by the comb-tooth electrode type electrostatic actuators 13 formed at the ends in the rotational direction. The comb-tooth electrode type electrostatic actuators 13 are driven by applying an AC voltage at 60 Hz between the comb-tooth electrodes 8a formed in the second movable frame 8 and the comb-tooth electrodes 11a formed in the fixed frame 11.

Here, the deflection angle of the mirror depends on the balance between the electrostatic force generated by the electrostatic actuator and the reaction force generated by torsion of the torsion beams 12, so that if the rigidity of the torsion beams 12 is designed so as to have a resonance frequency of hundreds of Hz or higher, at an AC voltage of 10V or lower, the mirror 2 deflects only several times.

Therefore, the inclined electrode type electrostatic actuator 14 shown in FIG. 10 is installed on the second movable frame 8. The reason for using the inclined electrode type electrostatic actuator is that the electrostatic force is inversely proportional to the square of the distance between the electrodes, so that if each fixed electrode is inclined and the distance to each movable electrode is brought limitlessly close to zero, a large electrostatic force can be obtained. However, to obtain a large deflection angle, the inclination angle must be inclined in correspondence to the deflection angle, so that at an early stage, a large electrostatic force cannot be obtained, thus the distance between the inclined electrodes is narrowed by the inclined electrode type electrostatic actuator 14 to obtain a large force.

As shown in FIG. 10, on the surface of the inclined electrodes 14, the insulators 52 are installed and function as a stopper when the second movable frame 8 is pulled near by the electrostatic force, so that the deflection angle of the second movable frame 8 is always controlled to the inclination angle of the inclined electrodes 14.

### Embodiment 3

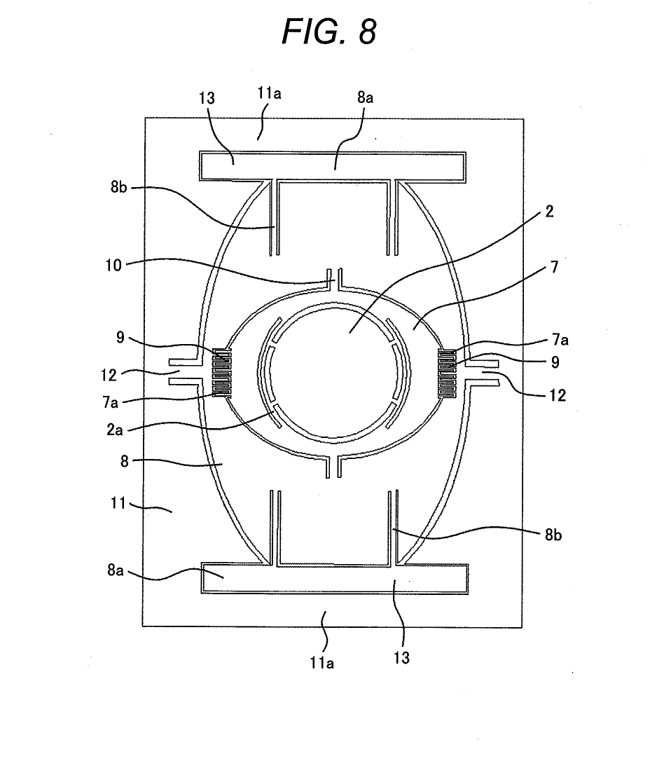

FIG. 8 is a front view of the biaxial electrostatic drive mirror device relating to Embodiment 3 of the present invention.

In FIG. 8, the mirror 2 for reflecting light is connected to the first movable frame 7 via the distortion separation portion 2a and is fixed in the same plane. The distortion separation portion 2a prevents the mirror 2 from deforming due to a temperature change or force applied at the time of mounting. The first movable frame 7 is connected to the second movable frame 8 with the torsion beams 10 symmetrically arranged on the axial line passing the center of the mirror 2 and rotates around the axis composed of the torsion beams 10 by the comb-tooth electrode type electrostatic actuators 9 formed at the ends in the rotational direction. If the first movable frame 7 is used to draw an image in the horizontal direction, the drive frequency thereof is high such as 10 kHz or higher.

When the resonance frequency is high like this, the comb-tooth electrode type electrostatic actuators 9 are driven by applying an AC voltage having the same frequency as the resonance frequency of the system including the structure existing inside the first movable frame 7 between the comb-tooth electrodes 7a formed in the first movable frame 7 and the comb-tooth electrodes 8a fixed to the second movable frame 8.

By doing this, the amplification of the deflection angle due to the resonance phenomenon is realized and even at a low voltage such as 10V or lower, the mirror 2 can be deflected at a large deflection angle for a rotary shaft of the torsion beams 10. Further, the amplification factor of the deflection angle due to the resonance phenomenon depends on the surrounding pressure and to increase the amplification factor, the drive system including the mirror 2 is hermetically sealed spatially at a low pressure. If the second movable frame 8 is used to draw an image in the vertical direction, the drive frequency thereof is 60 Hz.

When the drive frequency is low like this, if the resonance frequency is lowered, the behavior of the mirror 2 becomes unstable under the influence of a disturbance vibration and the second movable frame 8 becomes unsuitable for image drawing. Therefore, the dissonance drive is used and the resonance frequency of the system is set to hundreds of Hz or higher so as to be hardly affected by the disturbance vibration. The method for rotating the second movable frame 8 without using the phenomenon that the deflection angle due to the resonance phenomenon is amplified will be explained below.

The second movable frame 8 is connected to the fixed frame 11 with the torsion beams 12 formed on the axial line passing the center of the mirror 2 and rotates around the axis composed of the torsion beams 12 by the parallel flat plate type electrostatic actuators 13 formed at the ends in the rotational direction. The parallel flat plate type electrostatic actuators 13 are driven by applying an AC voltage at 60 Hz between the parallel flat plate movable electrodes 8a connected to the second movable frame 8 via the cantilever beam 8b and the parallel flat plate fixed electrodes 11a united with the fixed frame 11.

Here, the deflection angle of the mirror 2 depends on the balance between the electrostatic force generated by the electrostatic actuator and the reaction force generated by torsion of the torsion beams 12, so that if the rigidity of the torsion beams 12 is designed so as to have a resonance frequency of hundreds of Hz or higher, at an AC voltage of 10V or lower, the mirror 2 cannot be deflected largely.

Therefore, the cantilever beam 8b for supporting the parallel flat plate movable electrodes 11a is made thin, and the rigidity thereof is made small, thus even at a long inter-electrode distance, the parallel flat plate electrodes 8a are permitted to make contact with each other at a low voltage, and after the parallel flat plate electrodes 8a make contact with each other, the cantilever beam 8b supporting the movable electrodes is slowly adsorbed to the fixed electrodes by the electrostatic force from the side of the parallel flat plate electrodes 8a, thus the mirror 2 deflects largely, and after a specific deflection angle, the inclined electrode type electrostatic actuator 14 shown in FIG. 10 is installed in the second movable frame 8, and the mirror 2 is permitted to deflect at a larger deflection angle.

The reason for using the inclined electrode type electrostatic actuator is that the electrostatic force is inversely proportional to the square of the distance between the electrodes, so that if each fixed electrode is inclined and the distance to each movable electrode is brought limitlessly close to zero, a large electrostatic force can be obtained. However, to obtain a large deflection angle, the inclination angle must be inclined in correspondence to the deflection angle, so that at an early stage, a large electrostatic force cannot be obtained, thus the distance between the inclined electrodes is narrowed by the electrostatic actuator to obtain a large force.

As shown in FIG. 6, on the surface of the inclined electrodes 14, the insulators 52 are formed and function as a stopper when the second movable frame 8 is pulled near by the electrostatic force, so that the deflection angle of the second movable frame 8 is always controlled to the inclination angle of the inclined electrodes 14.

### Embodiment 4

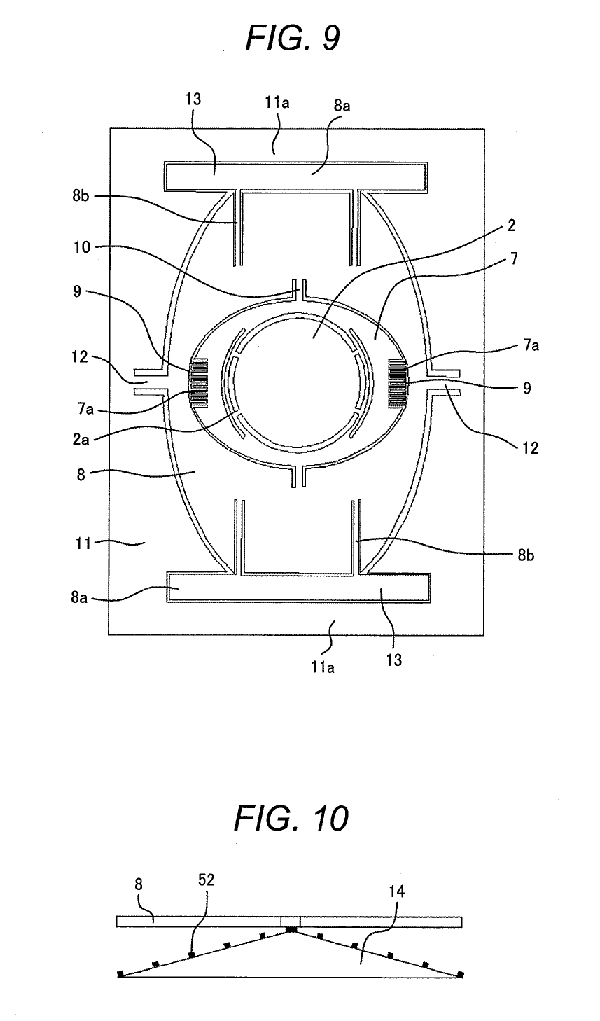

FIG. 9 is a front view of the biaxial electrostatic drive mirror device relating to Embodiment 4 of the present invention.

In FIG. 9, the mirror 2 for reflecting light is connected to the first movable frame 7 via the distortion separation structure 2a and is fixed in the same plane. The distortion separation structure 2a prevents the mirror 2 from deforming due to a temperature change or force applied at the time of mounting. The first movable frame 7 is connected to the second movable frame 8 with the torsion beams 10 symmetrically arranged on the axial line passing the center of the mirror 2 and rotates around the axis composed of the torsion beams 10 by the comb-tooth electrode type electrostatic actuators 9 formed at the ends in the rotational direction. If the first movable frame 7 is used to draw an image in the horizontal direction, the drive frequency thereof is high such as 10 kHz or higher.

When the resonance frequency is high like this, the comb-tooth electrode type electrostatic actuators 9 are driven by applying an AC voltage having the same frequency as the resonance frequency of the system including the structure existing inside the first movable frame 7 between the comb-tooth electrodes 7a formed in the first movable frame 7 and the comb-tooth electrodes 8a formed in the second movable frame 8.

By doing this, the amplification of the deflection angle due to the resonance phenomenon is realized and even at a low voltage such as 10V or lower, the mirror 2 can be deflected at a large deflection angle for a rotary shaft of the torsion beams 10. Further, the amplification factor of the deflection angle due to the resonance phenomenon depends on the surrounding pressure and to increase the amplification factor, the drive system including the mirror 2 is hermetically sealed spatially at a low pressure. If the second movable frame 8 is used to draw an image in the vertical direction, the drive frequency thereof is 60 Hz.

When the drive frequency is low like this, if the resonance frequency is lowered, the behavior of the mirror 2 becomes unstable under the influence of a disturbance vibration and the second movable frame 8 becomes unsuitable for image drawing. Therefore, the dissonance drive is used and the resonance frequency of the system is set to hundreds of Hz or higher so as to be hardly affected by the disturbance vibration. The method for rotating the second movable frame 8 without using the phenomenon that the deflection angle due to the resonance phenomenon is amplified will be explained below.

The second movable frame 8 is connected to the fixed frame 11 with the torsion beams 12 formed on the axial line passing the center of the mirror 2 and rotates around the axis composed of the torsion beams 12 by the parallel flat plate type electrostatic actuators 13 formed at the ends in the rotational direction. The parallel flat plate type electrostatic actuators 13 are driven by applying an AC voltage at 60 Hz between the parallel flat plate movable electrodes 8a connected to the second movable frame 8 via the cantilever beam 8b and the parallel flat plate fixed electrodes 11a united with the fixed frame 11.

Here, the deflection angle of the mirror depends on the balance between the electrostatic force generated by the electrostatic actuator and the reaction force generated by torsion of the torsion beams 12, so that if the rigidity of the torsion beams 12 is designed so as to have a resonance frequency of hundreds of Hz or higher, at an AC voltage of 10V or lower, the mirror cannot be deflected largely.

Therefore, the cantilever beam 8b for supporting the parallel flat plate movable electrodes is made thin, and the rigidity thereof is made small, thus even at a long inter-electrode distance, the parallel flat plate electrodes are permitted to make contact with each other at a low voltage, and after the parallel flat plate electrodes make contact with each other, the cantilever beam 8b supporting the movable electrodes is slowly adsorbed to the fixed electrodes by the electrostatic force from the side of the parallel flat plate electrodes 8a, thus the mirror 2 deflects largely, and after a specific deflection angle, the inclined electrode type electrostatic actuator 14 shown in FIG. 10 is installed in the large second movable frame 8, and the mirror 2 is permitted to deflect at a larger deflection angle.

The reason for using the inclined electrode type electrostatic actuator is that the electrostatic force is inversely proportional to the square of the distance between the electrodes, so that if each fixed electrode is inclined and the distance to each movable electrode is brought limitlessly close to zero, a large electrostatic force can be obtained. However, to obtain a large deflection angle, the inclination angle must be inclined in correspondence to the deflection angle, so that at an early stage, a large electrostatic force cannot be obtained, thus the distance between the inclined electrodes is narrowed by the electrostatic actuator 14 to obtain a large force.

As shown in FIG. 6, on the surface of the inclined electrodes 14, the insulators 52 are formed and function as a stopper when the second movable frame 8 is pulled near by the electrostatic force, so that the deflection angle of the second movable frame 8 is always controlled to the inclination angle of the inclined electrodes 14.

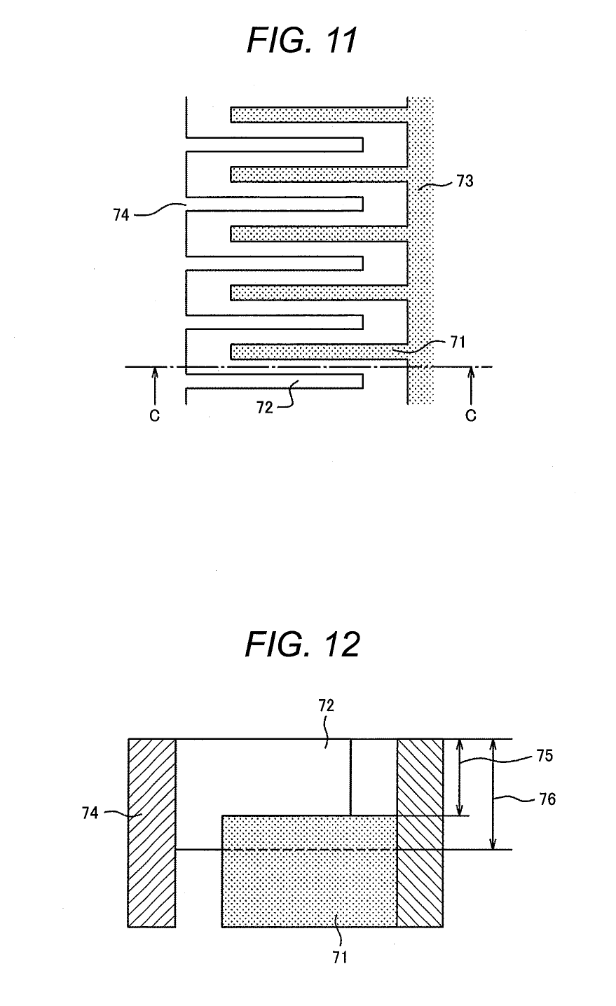

The comb-tooth type electrostatic actuator will be explained below by referring to FIGS. 11 and 12.

FIG. 11 is a partially enlarged view of the comb-tooth type actuator.

FIG. 12 is a cross sectional view of the line C-C shown in FIG. 11.

In FIG. 11, in a fixed frame 73, comb-tooth type electrostatic actuator fixed electrodes 71 formed in a comb-tooth shape are formed. Comb-tooth type electrostatic actuator movable electrodes 72 of a second movable frame 74 are attached so as to mesh with the comb teeth of the comb-tooth type electrostatic actuator fixed electrodes 71. The comb-tooth type electrostatic actuator movable electrodes 72 move vertically between the comb teeth of the comb-tooth type electrostatic actuator fixed electrodes 71.

In FIG. 12, the comb-tooth type electrostatic actuator movable electrodes 72 have a difference in the position before moving (an offset 75) from the reference position of the comb-tooth type electrostatic actuator fixed electrodes 71. The numeral 76 indicates the height of the comb-tooth type electrostatic actuator movable electrodes.

As mentioned above, according to the present invention, the first electrostatic actuator and the second electrostatic actuator which are different in properties are combined, and the second movable frame is moved, thus even at a low voltage, the mirror can be driven, and the movable frame is moved until the mirror makes contact with the insulators formed on the inclined electrodes, thereby a large deflection angle can be repeatedly obtained.

What is claimed is:

1. A mirror device comprising:
a mirror for scanning a laser beam on a face as a screen and projecting an image;
a first movable frame with said mirror attached to;
a second movable frame connected to said first movable frame via a first beam; and
a fixed frame connected to said second movable frame via a second beam; wherein:
comb teeth formed in said first movable frame and comb teeth formed in said second movable frame are combined, and a first electrostatic actuator is formed by combination of said comb teeth formed in said second movable frame with comb teeth formed in said fixed frame,
a second electrostatic actuator composed of inclined electrodes is installed under said first movable frame and said second movable frame, and
said mirror is operated horizontally and vertically by said first and second actuators.

2. The mirror device according to claim 1, wherein:
said mirror rotates biaxially by said first beam and said second beam.

3. The mirror device according to claim 1, wherein:
said second movable frame and said first electrostatic actuator support a parallel flat plate type electrostatic actuator with an elastic cantilever beam and
said parallel flat plate type electrostatic actuator operates, thus said cantilever beam changes elastically, and said second frame is structured so as to be inclined by a rotary motion on an axis of said second beam, and
said inclined electrodes of said second electrostatic actuator are formed so as to obtain an almost same inclination as a maximum inclination when said second movable frame more inclines and approaches by an operation of said second electrostatic actuator.

4. The mirror device according to claim 1, wherein:
said first actuator is a comb-tooth electrode type electrostatic actuator, and
positions in a height direction of said comb-tooth electrodes installed on a side of said second movable frame and said comb-tooth electrodes installed on a side of said fixed frame have an offset, and
after said second movable frame is rotated by electrostatic force when a voltage is applied between said comb-tooth electrodes and exceeds a predetermined rotational angle, force of said second electrostatic actuator using said inclined fixed electrodes increases, thus said mirror is rotated.

5. The mirror device according to claim 1, wherein:
said positions in said height direction of said comb-tooth electrodes installed on said side of said second movable frame and said comb-tooth electrodes installed on said side of said fixed frame have said offset and
an actuator for driving in a horizontal direction is an electrostatic actuator for rotating said first movable frame by said electrostatic force when said voltage is applied between said comb-tooth electrodes and is driven at a resonance frequency of a system with said first movable frame and said mirror united.

6. The mirror device according to claim 1, wherein:
said mirror and said first movable frame and second movable frame are hermetically sealed spatially with a cover where said second movable frame is joined to said fixed frame portion and
a pressure of said hermetically sealed space is 1,000 Pa or lower.
